(19) United States
(12) Patent Application Publication
(10) Pub. No.: US 2025/0253593 A1
(43) Pub. Date: Aug. 7, 2025

(54) SHIELD CONNECTOR

(71) Applicant: SUMITOMO WIRING SYSTEMS, LTD., Mie (JP)

(72) Inventors: Kazuya TAKEUCHI, Mie (JP); Long CHEN, Mie (JP)

(21) Appl. No.: 19/023,920

(22) Filed: Jan. 16, 2025

(30) Foreign Application Priority Data
Feb. 5, 2024 (JP) 2024-015474

(51) Int. Cl. H01R 13/6594; H01R 12/72

(52) U.S. Cl. CPC H01R 13/6594; H01R 12/722

(57) ABSTRACT

A shield connector 10 includes a terminal assembly 20 and a housing 50. The terminal assembly 20 includes an inner conductor 24, an outer conductor 25 and a dielectric 26. The inner conductor 24 includes a board side connecting portion 22. The outer conductor 25 includes a front wall 42, left and right side walls 43 and a rear wall 44 for surrounding an upper portion 28 of the board side connecting portion 22, and ground connecting portions 23. A visually confirmable gap is formed between a lower end 44S of the rear wall 44 and an upper surface of a circuit board 11 with the shield connector 10 connected to the circuit board 11, and all the board side connecting portion 22 and ground connecting portions 23 are arranged at positions shifted from each other in a lateral direction on the upper surface of the circuit board.

### CROSS-REFERENCE TO RELATED APPLICATIONS

This application is based on and claims priority from Japanese Patent Application No. 2024-015474, filed on Feb. 5, 2024, with the Japan Patent Office, the disclosure of which is incorporated herein in its entirety by reference.

### TECHNICAL FIELD

The present disclosure relates to a shield connector.

### BACKGROUND

Conventionally, a shield connector to be disposed on a circuit board is known, for example, as described in Japanese Patent Laid-open Publication Nos. 2012-069353, H11-067376, 2017-084669, 2022-035188, 2018-006152 and International Application Publication No. WO 2016/070958. A shield connector described in Japanese Patent Laid-open Publication No. 2022-035188 is provided with an inner conductor, an outer conductor, a dielectric and a housing for accommodating these. The inner conductor includes a board connecting portion to be inserted into a through-hole of the circuit board and soldered. The outer conductor includes connecting pieces to be inserted into through-holes of the circuit board and soldered.

### SUMMARY

In the shield connector as described above, it is desired to inspect parts soldered to the circuit board from outside visually or by a camera or the like. However, in the shield connector as described above, it has been difficult to inspect the soldered state since a gap between the shield connector and the circuit board is small or the parts to be soldered to the circuit board overlap when viewed from outside.

Accordingly, the present disclosure aims to provide a shield connector enabling a soldered state to be easily inspected.

The present disclosure is directed to a shield connector to be connected to a circuit board, the shield connector being provided with a terminal assembly and a housing for accommodating the terminal assembly, the terminal assembly including an inner conductor, an outer conductor and a dielectric to be arranged between the inner conductor and the outer conductor, the inner conductor including a board side connecting portion extending downward toward the circuit board, a lower portion of the board side connecting portion being inserted into a through-hole of the circuit board and soldered, the outer conductor including a front wall, left and right side walls and a rear wall for surrounding an upper portion of the board side connecting portion, and ground connecting portions extending toward the circuit board from lower ends of the respective front wall, left and right side wall and rear wall and to be inserted into through-holes of the circuit board and soldered, and a visually confirmable gap being formed between the lower end of the rear wall and an upper surface of the circuit board with the shield connector connected to the circuit board, all the board side connecting portion and ground connecting portions being arranged at positions shifted from each other in a lateral direction on the upper surface of the circuit board.

According to the present disclosure, it is possible to provide a shield connector enabling a soldered state to be easily inspected.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a shield connector according to one embodiment in a state connected to a circuit board.

FIG. 2 is a front view showing the shield connector in the state connected to the circuit board.

FIG. 3 is a back view showing the shield connector in the state connected to the circuit board.

FIG. 4 is an exploded perspective view showing terminal assemblies and a housing.

FIG. 5 is an exploded perspective view showing the terminal assembly.

FIG. 6 is a partial enlarged section showing the shield connector in the state connected to the circuit board.

FIG. 7 is a side view showing the terminal assembly.

FIG. 8 is a back view showing the terminal assembly.

FIG. 9 is a partial enlarged bottom view of the terminal assembly showing the arrangement of board side connecting portions and ground connecting portions.

FIG. 10 is a partial enlarged back view showing the arrangement of the board side connecting portions and the ground connecting portions when the shield connector in the state connected to the circuit board is viewed from behind.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The shield connector of the present disclosure is to be connected to a circuit board and provided with a terminal assembly and a housing for accommodating the terminal assembly, the terminal assembly including an inner conductor, an outer conductor and a dielectric to be arranged between the inner conductor and the outer conductor, the inner conductor including a board side connecting portion extending downward toward the circuit board, a lower portion of the board side connecting portion being inserted into a through-hole of the circuit board and soldered, the outer conductor including a front wall, left and right side walls and a rear wall for surrounding an upper portion of the board side connecting portion, and ground connecting portions extending toward the circuit board from lower ends of the respective front wall, left and right side wall and rear wall and to be inserted into through-holes of the circuit board and soldered, and a visually confirmable gap being formed between the lower end of the rear wall and an upper surface of the circuit board with the shield connector connected to the circuit board, all the board side connecting portion and ground connecting portions being arranged at positions shifted from each other in a lateral direction on the upper surface of the circuit board. According to this configuration, all the board side connecting portion and ground connecting portions can be individually visually confirmed from behind the shield connector via the gap between the lower end of the rear wall and the upper surface of the circuit board, wherefore a soldered state can be easily inspected.

[2] In the shield connector of [1] described above, the lower end of the rear wall is located above a lower surface of the housing with the shield connector connected to the circuit board. According to this configuration, the ground connecting portion on the front wall is easily visually confirmed from behind the shield connector as compared to the case where the lower end of the rear wall is located at the same height position as or below the lower surface of the housing, wherefore the soldered state can be more easily inspected.

[3] In the shield connector of [1] or [2] described above, an interval in the lateral direction between the ground connecting portion on the front wall and the board side connecting portion adjacent to each other on one side in the lateral direction when viewed from behind is larger than an interval in the lateral direction between the ground connecting portion on the side wall and the ground connecting portion on the rear wall adjacent to each other. According to this configuration, the soldered state can be more easily inspected by enlarging the interval in the lateral direction between the ground connecting portion on the front wall and the board side connecting portion difficult to visually confirm from lateral sides as compared to the ground connecting portions on the side walls and the ground connecting portion on the rear wall easily visually confirmed from the lateral sides.

### Details of Embodiment of Present Disclosure

A specific example of a shield connector of the present disclosure is described below with reference to the drawings. Note that the present invention is not limited to these illustrations, but is represented by claims and intended to include all changes in the scope of claims and in the meaning and scope of equivalents.

### Embodiment

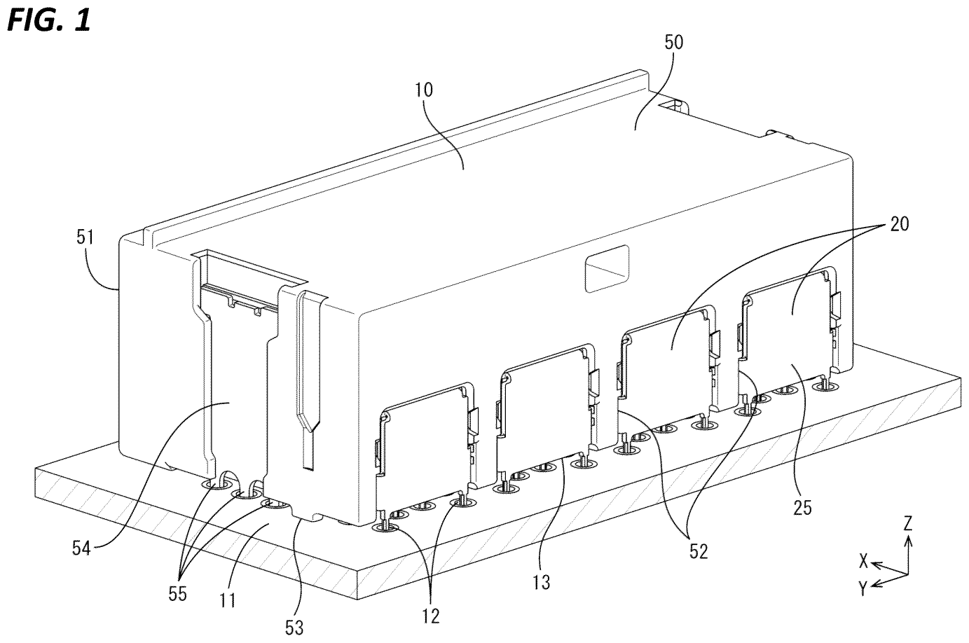

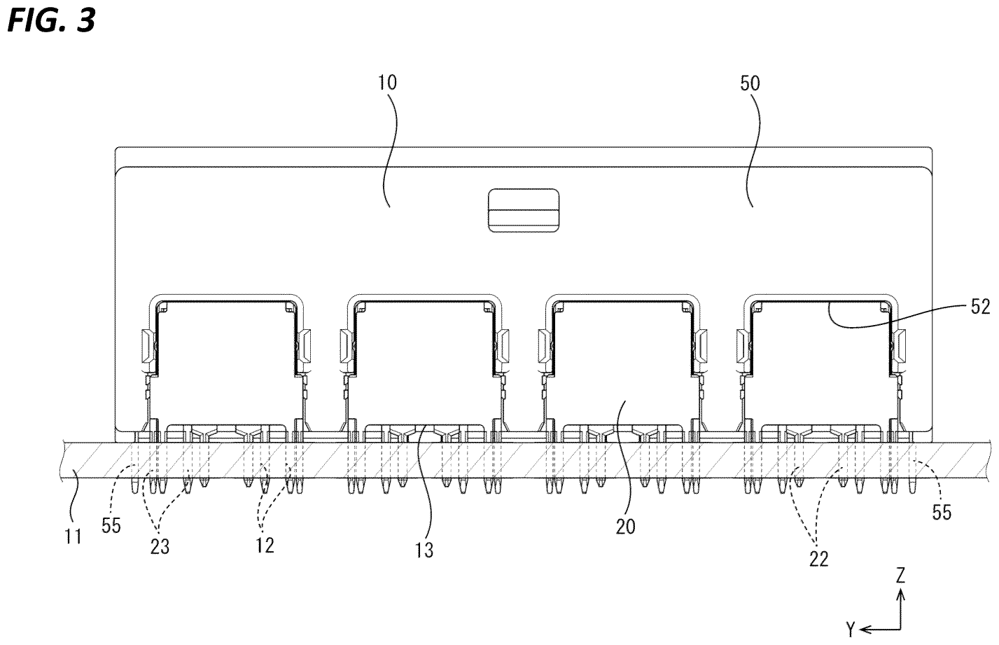

A shield connector 10 is a board connector to be connected to a circuit board 11 as shown in FIGS. 1 to 4. The shield connector 10 is provided with terminal assemblies 20, a housing 50 and fixing members 54. The terminal assembly 20 includes mating side connecting portions 21, board side connecting portions 22 and ground connecting portions 23. The housing 50 accommodates four terminal assemblies 20. The fixing members 54 are provided in the housing 50 and fixed to the circuit board 11.

The circuit board 11 is formed with a plurality of through-holes 12. Projecting pins 55 of the fixing members 54, the board side connecting portions 22 and the ground connecting portions 23 are inserted into the respective through-holes 12. Unillustrated solder is applied to each through-hole 12 in advance. The shield connector 10 fixed to the upper surface of the circuit board 11 is soldered to the circuit board 11 by a reflow process.

In the following description, a positive direction side of an X axis in each figure is referred to as a front side, a negative direction side of the X axis is referred to as a rear side, a positive direction side of a Y axis in each figure is referred to as a left side, a negative direction side of the Y axis is referred to as a right side, a positive direction side of a Z axis in each figure is referred to as an upper side and a negative direction side of the Z axis is referred to as a lower side in each constituent member. The X axis is parallel to a connection direction to an unillustrated mating connector. The Z axis is perpendicular to plate surfaces of the circuit board 11. “Parallel” means a substantially parallel state in addition to a strictly parallel state. “Perpendicular” means a substantially perpendicular state in addition to a strictly perpendicular state.

The housing 50 is made of synthetic resin and includes, as shown in FIGS. 1 to 4, a receptacle 51, four terminal accommodating portions 52 and a plurality of supporting portions 53. The receptacle 51 is open forward. The mating connector is fit into the receptacle 51. The receptacle 51 collectively surrounds front end parts of the four terminal assemblies 20.

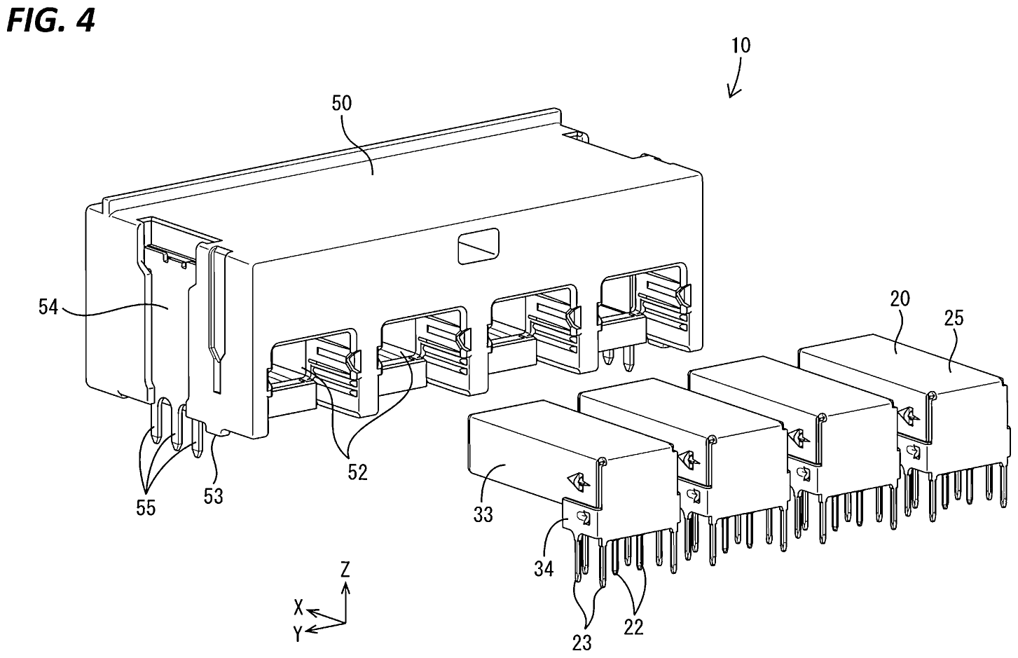

As shown in FIG. 4, each terminal accommodating portion 52 is open rearward. The terminal assembly 20 is accommodated into the terminal accommodating portion 52 from behind. A rear end part of the terminal accommodating portion 52 is open downward. A front end part of the terminal accommodating portion 52 is open forward.

The plurality of supporting portions 53 project downward from a lower surface 50S of the housing 50. Each supporting portion 53 contacts the upper surface of the circuit board 11. The lower surface 50S of the housing 50 is arranged in a state lifted upward from the upper surface of the circuit board 11 by the plurality of supporting portions 53. In this way, an appropriate space for soldering is formed between the lower surface 50S of the housing 50 and the upper surface of the circuit board 11.

The fixing members 54 are mounted on both left and right sides of the housing 50. The fixing member 54 includes three projecting pins 55 projecting downward. The projecting pins 55 of the fixing member 54 are respectively inserted into the through-holes 12 of the circuit board 11 and soldered. The housing 50 is fixed to the upper surface of the circuit board 11 by the fixing members 54.

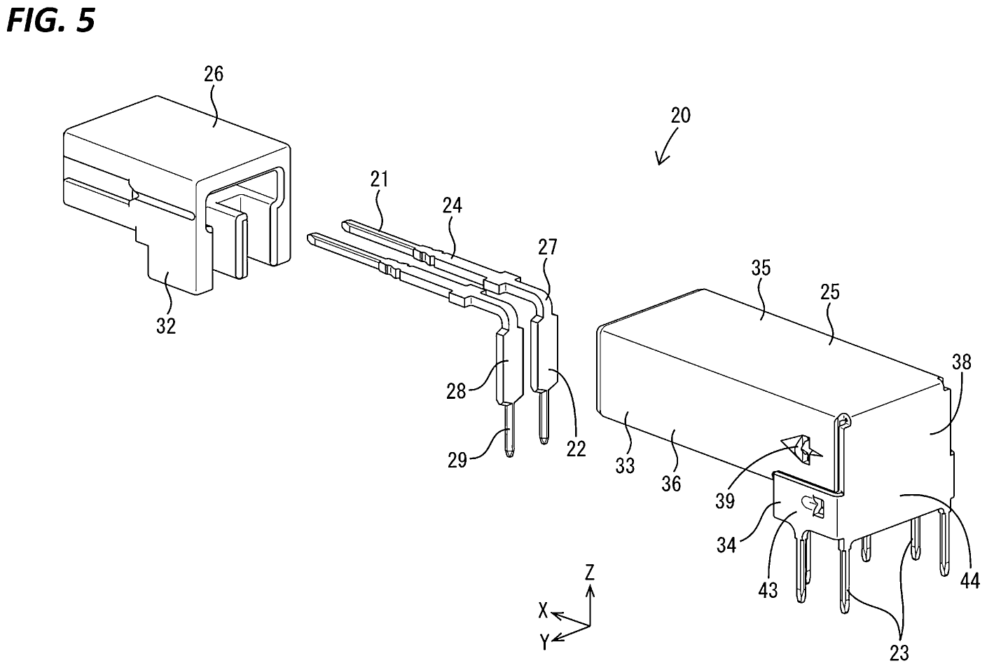

As shown in FIG. 5, the terminal assembly 20 includes two inner conductors 24, an outer conductor 25 and a dielectric 26.

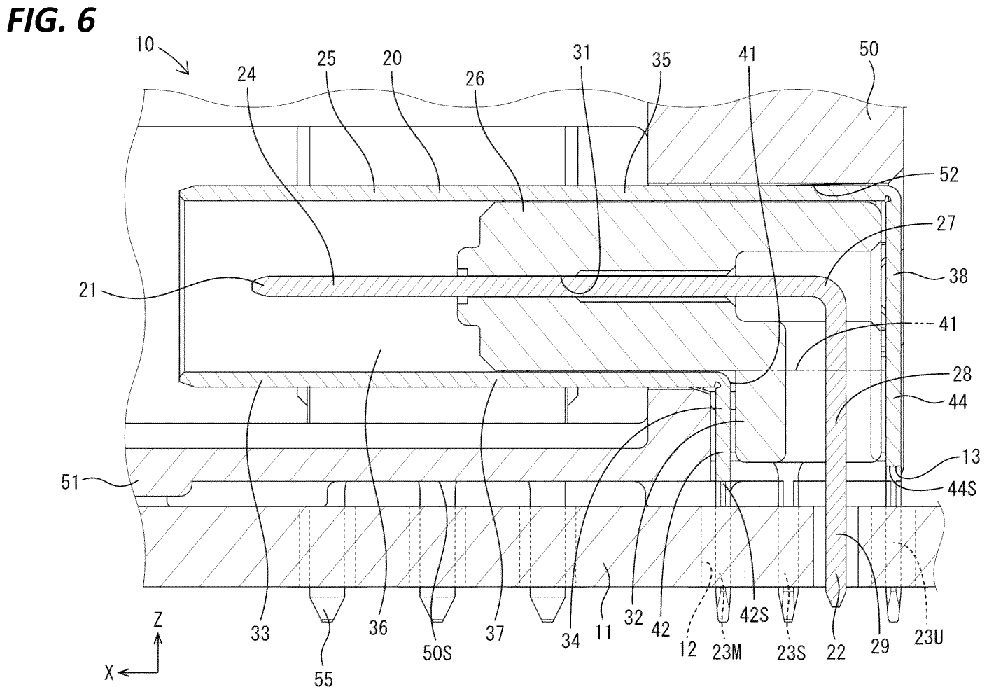

The inner conductor 24 has an elongated L shape. The inner conductor 24 includes the mating side connecting portion 21, a terminal bending portion 27 and the board side connecting portion 22. The mating side connecting portion 21 is connected to an unillustrated mating terminal fitting. The mating side connecting portion 21 extends forward from the terminal bending portion 27. The mating side connecting portion 21 projects forward from the dielectric 26 (see FIG. 6).

The board side connecting portion 22 extends downward toward the circuit board 11 from the terminal bending portion 27. The board side connecting portion 22 includes an upper portion 22 and a lower portion 29. A width in a lateral direction of the upper portion 28 is larger than that of the lower portion 29. The lower portion 29 of the board side connecting portion 22 is inserted into the through-hole 12 of the circuit board 11 and soldered to an electrically conductive part for signal. As shown in FIGS. 5 and 6, the inner conductor 24 is inserted into a mounting hole 31 of the dielectric 26 from behind and mounted in the dielectric 26. With the inner conductor 24 mounted in the dielectric 26, the board side connecting portion 22 is exposed from the dielectric 26 and seen from behind.

The dielectric 26 is made of synthetic resin. The dielectric 26 is arranged between the inner conductors 24 and the outer conductor 25. As shown in FIG. 6, the dielectric 26 includes the mounting holes 31 for the inner conductors 24. The mounting hole 31 is a hole formed to penetrate through the dielectric 26 in a front-rear direction. A rear end part of the dielectric 26 includes a projecting portion 32 projecting downward. The projecting portion 32 is surrounded by a lower portion 34 of the outer conductor 25 to be described later.

As shown in FIG. 5, the outer conductor 25 is formed, such as by bending an electrically conductive metal plate material. The outer conductor 25 includes a body portion 33, the lower portion 34 and six ground connecting portions 23. A mating outer conductor of the unillustrated mating connector enters the inside of the outer conductor 25 and is electrically connected to the outer conductor 25 by a resilient contact piece of the mating outer conductor.

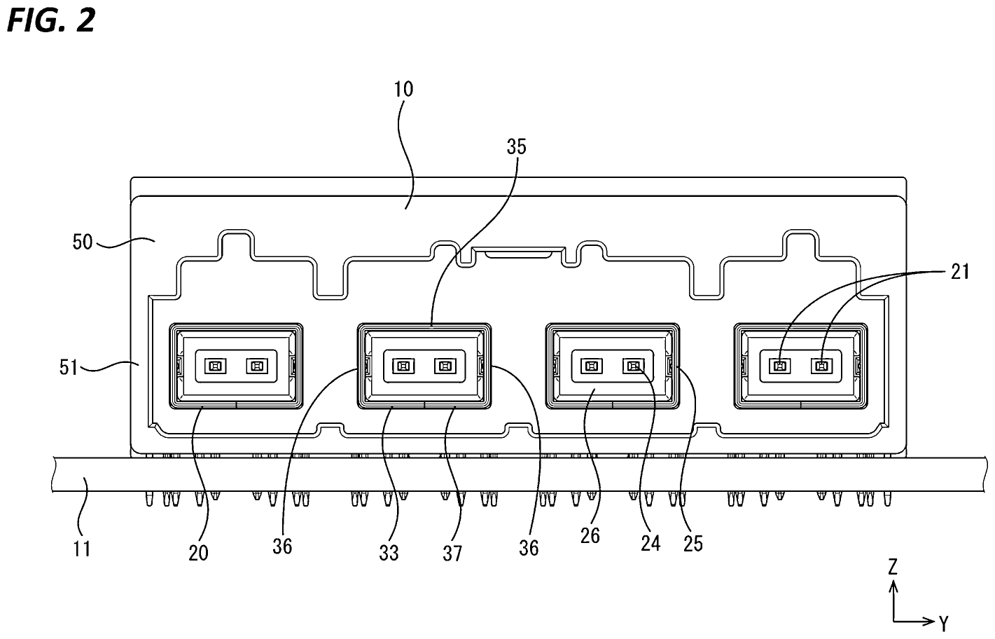

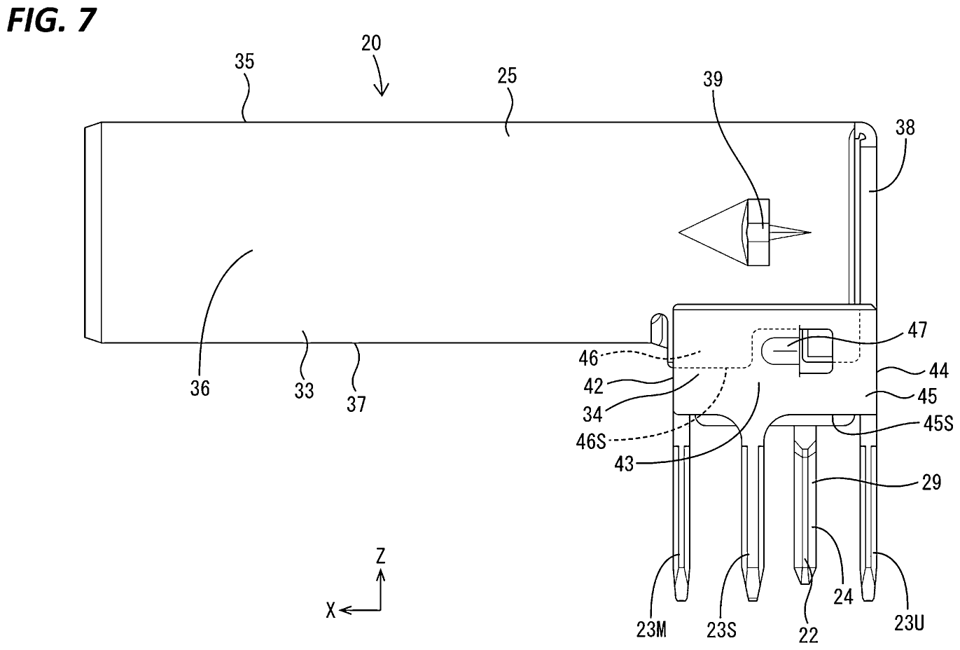

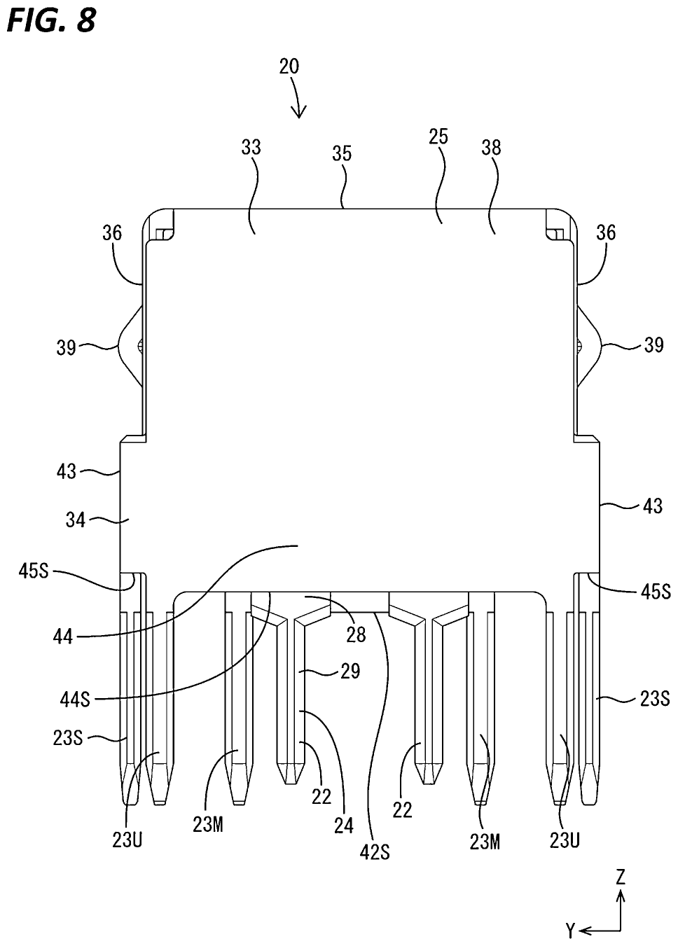

The body portion 33 is in the form of a rectangular tube open forward (see FIG. 2). The body portion 33 includes a ceiling plate portion 35, left and right side plate portions 36, a bottom plate portion 37 and a rear plate portion 38. Locking projections 39 are provided on rear sides of the left and right side plate portions 36 as shown in FIGS. 7 and 8. The locking projections 39 project laterally outward on the left and right side plate portions 36. The locking projections 39 are locked to the housing 50. In this way, rearward detachment of the terminal assembly 20 from the housing 50 is suppressed with the terminal assembly 20 accommodated in the terminal accommodating portion 52.

The rear plate portion 38 closes the rear surface of the body portion 33 as shown in FIG. 6. The rear plate portion 38 is bent downward from the rear end of the ceiling plate portion 35. The rear end of the bottom plate portion 37 is located forward of those of the ceiling plate portion 35 and the left and right side plate portions 36. A terminal opening 41 open in a vertical direction is formed between the rear end of the bottom plate portion 37 and the rear plate portion 38. The board side connecting portion 22 extends to the inside of the lower portion 34 through the terminal opening 41 from the inside of the body portion 33.

As shown in FIG. 6, the lower portion 34 of the outer conductor 25 surrounds the upper portions 28 of the board side connecting portions 22 and the projecting portion 32 of the dielectric 26. The lower end of the projecting portion 32 of the dielectric 26 is arranged above the lower end of the lower portion 34 of the outer conductor 25. The lower portions 29 of the board side connecting portions 22 are arranged below the lower end of the lower portion 34 of the outer conductor 25 (see FIG. 8).

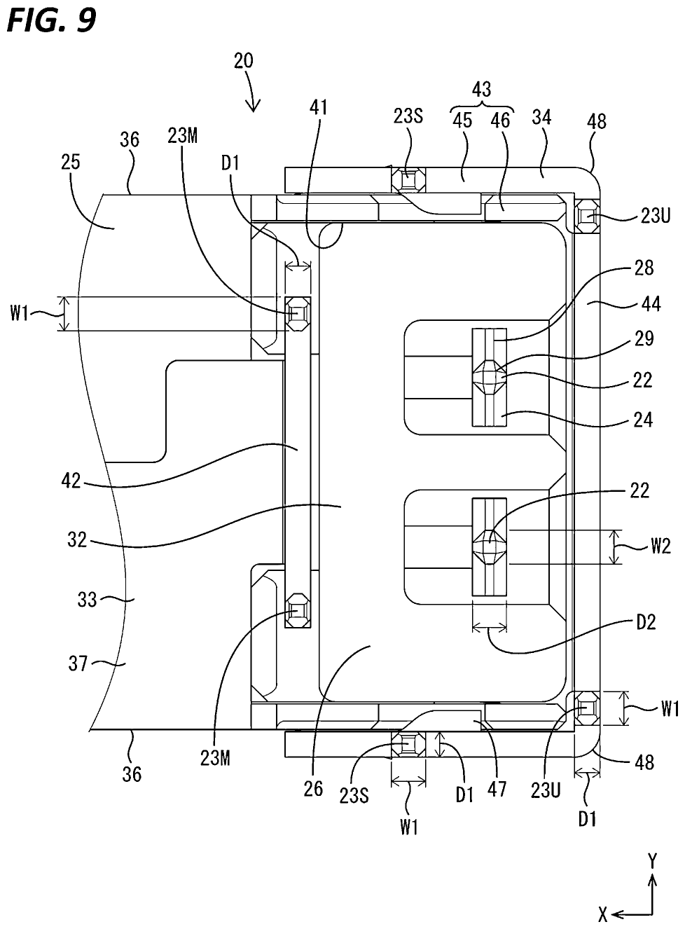

The lower portion 34 of the outer conductor 25 is in the form of a rectangular tube as shown in FIG. 9. The lower portion 34 of the outer conductor 25 includes a front wall 42, left and right side walls 43 and a rear wall 44. The front wall 42 is bent downward from the rear end of the bottom plate portion 37 as shown in FIG. 6. A lower end 42S of the front wall 42 is located at a height position below a lower end 44S of the rear wall 44 in the vertical direction (see FIG. 8).

As shown in FIG. 9, each of the left and right side walls 43 includes an outer wall 45 and an inner wall 46. The outer wall 45 and the inner wall 46 are held in an overlapping state by a locking portion 47. The outer walls 45 are connected to both left and right end parts of the rear wall 44. The left and right outer walls 45 are bent forward from the both left and right end parts of the rear wall 44. The inner walls 46 are parts extending downward from rear parts of the left and right side plate portions 36 (see FIG. 7). A lower end 46S of the inner wall 46 is located above a lower end 45S of the outer wall 45. The lower end 45S of the outer wall 45 is located above the lower end 44S of the rear wall 44. The rear wall 44 is a part continuous with and extending downward from the rear plate portion 38.

As shown in FIGS. 7 and 8, the ground connecting portions 23 extend downward from the lower end of the lower portion 34 of the outer conductor 25. Each ground connecting portion 23 is inserted into the through-hole 12 of the circuit board 11 and soldered to an electrically conductive part for ground.

As shown in FIG. 9, the ground connecting portions 23 are provided on the lower ends of the front wall 42, the left and right side walls 43 and the rear wall 44. The ground connecting portions 23 provided on the front wall 42 are referred to as front wall ground connecting portions 23M, the ground connecting portions 23 provided on the left and right side walls 43 are referred to as side wall ground connecting portions 23S, and the ground connecting portions 23 provided on the rear wall 44 are referred to as rear wall ground connecting portions 23U. The six ground connecting portions 23 are arranged at positions surrounding the two board side connecting portions 22. The six ground connecting portions 23 are bilaterally symmetrically arranged with respect to a lateral center of the terminal assembly 20.

One front wall ground connecting portion 23M is arranged near each of left and right ends of the front wall 42. An interval in the lateral direction between the left and right front wall ground connecting portions 23M is larger than an interval in the lateral direction between the lower portions 29 of the board side connecting portions 22.

One side wall ground connecting portion 23S is provided on each of the outer walls 45. The side wall ground connecting portions 23S are shifted in the lateral direction from the rear wall ground connecting portions 23U by a thickness of the metal plate material constituting the outer conductor 25. The left and right side wall ground connecting portions 23S are located laterally outward of the rear wall ground connecting portions 23U. The side wall ground connecting portions 23S are arranged near a center between the front wall ground connecting portions 23M and the rear wall ground connecting portions 23U in a front-rear direction. As shown in FIG. 7, the board side connecting portions 22 are arranged between the side wall ground connecting portions 23S and the rear wall ground connecting portions 23U in the front-rear direction.

One rear wall ground connecting portion 23U is provided on each of both left and right end parts of the rear wall 44. The rear wall ground connecting portions 23U are adjacent to corner portions 48 on the both left and right end parts of the rear wall 44. The corner portion 48 is a bent portion between the rear wall 44 and the outer wall 45. The corner portion 48 has a curved surface. The rear wall ground connecting portions 23U are provided laterally inward of the corner portions 48.

Widths W1 of the front wall ground connecting portions 23M, the side wall ground connecting portions 23S and the rear wall ground connecting portions 23U are equal. The widths W1 of the front wall ground connecting portions 23M and the rear wall ground connecting portions 23U are respectively dimensions in the lateral direction. The widths W1 of the side wall ground connecting portions 23S are dimensions in the front-rear direction of the side wall ground connecting portions 23S.

The widths W1 of the front wall ground connecting portions 23M, the side wall ground connecting portions 23S and the rear wall ground connecting portions 23U are equal to a width W2 of the board side connecting portion 22. The width W2 of the board side connecting portion 22 is a dimension in the lateral direction of the lower portion 29 of the board side connecting portion 22.

Thicknesses D1 of the front wall ground connecting portions 23M, the side wall ground connecting portions 23S and the rear wall ground connecting portions 23U are equal. The thicknesses D1 of the front wall ground connecting portions 23M and the rear wall ground connecting portions 23U are respectively dimensions in the front-rear direction. The thicknesses D1 of the side wall ground connecting portions 23S are dimensions in the lateral direction of the side wall ground connecting portions 23S. The thicknesses D1 of the front wall ground connecting portions 23M, the side wall ground connecting portions 23S and the rear wall ground connecting portions 23U are equal to a thickness of the metal plate material constituting the outer conductor 25.

The thicknesses D1 of the front wall ground connecting portions 23M, the side wall ground connecting portions 23S and the rear wall ground connecting portions 23U are smaller than a thickness D2 of the board side connecting portion 22. The thickness D2 of the board side connecting portion 22 is a dimension in the front-rear direction of the lower portion 29 of the board side connecting portion 22.

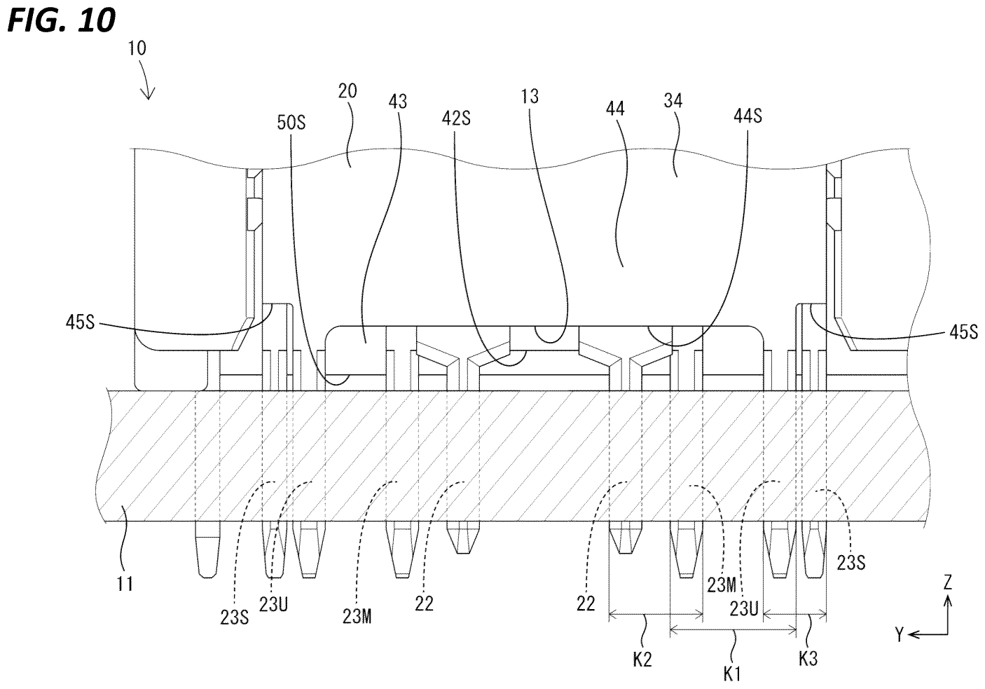

With the shield connector 10 connected to the circuit board 11, a window portion 13 is formed below the lower portion 34 of the outer conductor 25 as shown in FIG. 10. The window portion 13 is a gap formed between the lower end 44S of the rear wall 44 and the upper surface of the circuit board 11. The window portion 13 spreads in the lateral direction along the upper surface of the circuit board 11. A dimension in the vertical direction of the window portion 13 (dimension between the lower end 44 of the rear wall 44 and the upper surface of the circuit board 11) is constant in the lateral direction. The window portion 13 is formed between the left and right rear wall ground connecting portions 23U. With the shield connector 10 connected to the circuit board 11, the lower end 44S of the rear wall 44 is located above the lower end 42S of the front wall 42.

All the board side connecting portions 22 and ground connecting portions 23 are arranged at positions shifted from each other in the lateral direction on the upper surface of the circuit board 11 as shown in FIG. 10. When viewed from behind, the two board side connecting portions 22 are arranged apart from each other in the lateral direction in a central part in the lateral direction of the window portion 13. When viewed from behind, the two front wall ground connecting portions 23M are arranged laterally apart from the board side connecting portions 22 on laterally outer sides of the two board side connecting portions 22. When viewed from behind, the two rear wall ground connecting portions 23U are arranged laterally apart from the front wall ground connecting portions 23M on laterally outer sides of the two front wall ground connecting portions 23M. When viewed from behind, the two side wall ground connecting portions 23S are arranged laterally apart from the rear wall ground connecting portions 23U on laterally outer sides of the two rear wall ground connecting portions 23U.

An interval K1 in the lateral direction between the front wall ground connecting portion 23M and the rear wall ground connecting portion 23U adjacent when viewed from behind is larger than an interval K2 in the lateral direction between the board side connecting portion 22 and the front wall ground connecting portion 23M adjacent when viewed from behind. The interval K2 in the lateral direction between the front wall ground connecting portion 23M and the board side connecting portion 22 adjacent when viewed from behind is larger than an interval K3 in the lateral direction between the side wall ground connecting portion 23S and the rear wall ground connecting portion 23U adjacent when viewed from behind. The interval K1 in the lateral direction is an interval between the lateral outer ends of the front wall ground connecting portion 23M and the rear wall ground connecting portion 23U adjacent when viewed from behind. The interval K2 in the lateral direction is an interval between the lateral outer ends of the board side connecting portion 22 and the front wall ground connecting portion 23M adjacent when viewed from behind. The interval K3 in the lateral direction is an interval between the lateral outer ends of the side wall ground connecting portion 23S and the rear wall ground connecting portion 23U adjacent when viewed from behind.

With the shield connector 10 connected to the circuit board 11, the two front wall ground connecting portion 23M and the two board side connecting portions 22 are individually visually confirmed from behind via the window portion 13 including the upper surface of the circuit board 11. With the shield connector 10 connected to the circuit board 11, soldered parts of all the board side connecting portions 22 and ground connecting portions 23 can be easily inspected visually or by a camera or the like from behind the upper surface of the shield connector 10 or below.

Next, functions and effects of the embodiment configured as described above are described. The shield connector 10 is connected to the circuit board 11. The shield connector 10 is provided with the terminal assemblies 20 and the housing 50 for accommodating the terminal assemblies 20. The terminal assembly 20 includes the inner conductors 24, the outer conductor 25 and the dielectric 26 to be arranged between the inner conductors 24 and the outer conductor 25. The inner conductor 24 includes the board side connecting portion 22 extending downward toward the circuit board 11. The lower portion 29 of the board side connecting portion 22 is inserted into the through-hole 12 of the circuit board 11 and soldered. The outer conductor 25 includes the front wall 42, the left and right side walls 43, the rear wall 44 and the ground connecting portions 23. The front wall 42, the left and right side walls 43 and the rear wall 44 surround the upper portions 28 of the board side connecting portions 22. The ground connecting portions 23 extend toward the circuit board 11 from the lower ends of the respective front wall 42, left and right side walls 43 and rear wall 44 and are inserted into the through-holes 12 of the circuit board 11 and soldered. With the shield connector 10 connected to the circuit board 11, the gap is formed between the lower end 44S of the rear wall 44 and the upper surface of the circuit board 11. All the board side connecting portions 22 and ground connecting portions 23 are arranged at the positions shifted from each other in the lateral direction on the upper surface of the circuit board 11. According to this configuration, the two board side connecting portions 22 and the six ground connecting portions 23 can be individually visually confirmed from behind the upper surface of the shield connector 10 via the gap between the lower end 44S of the rear wall 44 and the upper surface of the circuit board 11, wherefore the soldered state of all the board side connecting portions 22 and ground connecting portions 23 can be easily inspected.

With the shield connector 10 connected to the circuit board 11, the lower end 44S of the rear wall 44 is located above the lower end 42S of the front wall 42. According to this configuration, the ground connecting portions 23 on the front wall 42 are easily visually confirmed from behind the shield connector 10 as compared to the case where the lower end 44S of the rear wall 44 is located at the same height as or below the lower end 42S of the front wall 42, wherefore the soldered state of all the board side connecting portions 22 and ground connecting portions 23 can be more easily inspected.

The interval K2 in the lateral direction between the front wall ground connecting portion 23M and the board side connecting portion 22 adjacent on one side (left or right side) when viewed from behind is larger than the interval K3 in the lateral direction between the side wall ground connecting portion 23S and the rear wall ground connecting portion 23U adjacent in the lateral direction when viewed from behind. According to this configuration, the soldered state of all the board side connecting portions 22 and ground connecting portions 23 can be more easily inspected by enlarging the interval in the lateral direction between the front wall ground connecting portion 23M and the board side connecting portion 22 on the one side difficult to visually confirm from behind as compared to the side wall ground connecting portions 23S and the rear wall ground connecting portions 23U easily visually confirmed from outside.

### Other Embodiments of Present Disclosure

The embodiment disclosed this time should be considered illustrative in all aspects, rather restrictive.

Although the six ground connecting portions 23 are provided in the case of the above embodiment, the number of ground connecting portions may be changed as another embodiment.

Although the shield connector 10 is provided with the four terminal assemblies 20 in the case of the above embodiment, the number of terminal assemblies may be changed as another embodiment.

Although the specific arrangement of the board side connecting portions 22 and the ground connecting portions 23 is illustrated in the case of the above embodiment, the arrangement of board side connecting portions and ground connecting portions may be changed as appropriate if these are at positions shifted from each other in the lateral direction on the upper surface of a circuit board.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield connector to be connected to a circuit board, comprising:
a terminal assembly; and
a housing for accommodating the terminal assembly,
the terminal assembly including an inner conductor, an outer conductor and a dielectric to be arranged between the inner conductor and the outer conductor,
the inner conductor including a board side connecting portion extending downward toward the circuit board,
a lower portion of the board side connecting portion being inserted into a through-hole of the circuit board and soldered,
the outer conductor including a front wall, left and right side walls and a rear wall for surrounding an upper portion of the board side connecting portion, and ground connecting portions extending toward the circuit board from lower ends of the respective front wall, left and right side wall and rear wall and to be inserted into through-holes of the circuit board and soldered, and
a visually confirmable gap being formed between the lower end of the rear wall and an upper surface of the circuit board with the shield connector connected to the circuit board, all the board side connecting portion and ground connecting portions being arranged at positions shifted from each other in a lateral direction on the upper surface of the circuit board.

2. The shield connector of claim 1, wherein the lower end of the rear wall is located above the lower end of the front wall with the shield connector connected to the circuit board.

3. The shield connector of claim 1, wherein an interval in the lateral direction between the ground connecting portion on the front wall and the board side connecting portion adjacent to each other on one side in the lateral direction when viewed from behind is larger than an interval in the lateral direction between the ground connecting portion on the side wall and the ground connecting portion on the rear wall adjacent to each other.
